(19) United States
(12) Patent Application Publication
(10) Pub. No.: US 2025/0306770 A1
(43) Pub. Date: Oct. 2, 2025

(54) STORAGE SYSTEM, AND DATA DUPLICATION METHOD IN STORAGE

(71) Applicant: Hitachi Vantara, Ltd., Kanagawa-ken (JP)

(72) Inventors: Mai NOZUKI, Tokyo (JP); Naoyuki MASUDA, Tokyo (JP); Takaki MATSUSHITA, Tokyo (JP); Yusuke YAMAGA, Tokyo (JP)

(21) Appl. No.: 18/830,360

(22) Filed: Sep. 10, 2024

(30) Foreign Application Priority Data
Mar. 29, 2024 (JP) 2024-057780

(51) Int. Cl. G06F 3/06

(52) U.S. Cl. CPC G06F 3/0619; G06F 3/0647; G06F 3/065; G06F 3/0683

(57) ABSTRACT

A storage system 201 generates meta information management information that manages correspondence among family identification information, intra-family identification information and reference destination meta information. Further, the storage system 201 generates conversion information that manages correspondence among each of identification information of a primary logical volume and identification information of a secondary logical volume, the family identification information, and the intra-family identification information. The storage system 201 acquires the corresponding family identification information and the corresponding intra-family identification information from the identification information of the primary logical volume and the secondary logical volume with reference to the conversion information in response to an access request from a host apparatus. Then, the storage system 201 acquires reference destination meta information respectively corresponding to the primary logical volume and the secondary logical volume with reference to the meta information management information based on the acquired information to access data.

### INCORPORATION BY REFERENCE

This application claims priority based on Japanese patent application, No. 2024-057780 filed on Mar. 29, 2024, the entire contents of which are incorporated herein by reference.

### BACKGROUND

The present invention relates to a storage system and a data duplication method in a storage.

In recent years, there are increasing needs of data utilization, and opportunities of data duplication have been increased. Correspondingly, a volume duplication function becomes more and more important in a storage system. As such a volume duplication function, an existing technique creates a Snapshot of a logical volume (LDEV) within a local storage at high speed. In this technique, by employing a scheme (redirect-on-write (RoW)) of updating only metadata indicating a storage position of data without copying (moving) the data, high-speed division (creation of the Snapshot) and high-speed restoration (data restoration from the Snapshot) are achieved. Further, there has been proposed a related art intended to prevent degradation of I/O performance by copying meta information upon division and restoration of the data in the ROW (see, for example, Japanese Patent Laid-Open No. 2022-26812).

In this related art, by defining a relationship called a pair of a primary logical volume and a secondary logical volume of the Snapshot, relevance of data is managed, and management operation of the Snapshot such as division and restoration of the data is executed in pairs.

However, a problem with the above-described related art is that management operation of the Snapshot cannot be executed between logical volumes to which a pair relationship cannot be provided even if the logical volumes are related to the Snapshot. Examples of the logical volumes to which the pair relationship cannot be provided include, for example, a logical volume obtained by further duplicating a secondary logical volume with respect to a primary logical volume, and the primary logical volume, and further, two secondary logical volumes with respect to the primary logical volume. In this manner, the pair relationship cannot be provided to the logical volumes in which generations of the Snapshot are not consecutive, thereby the management operation of the Snapshot cannot be executed.

An object of the present invention, which has been made in view of the above-described problem, is to enable management operation of the Snapshot even between the logical volumes to which the pair relationship cannot be provided in the storage system.

### SUMMARY

To achieve the above-described object, the present invention provides a storage system including a storage controller which provides a plurality of logical volumes to a host apparatus and which is capable of creating a snapshot as a secondary logical volume that is a duplication of a primary logical volume, the storage controller managing respective pieces of information of pair management information that manages correspondence between a pair of identification information of the primary logical volume and identification information of the secondary logical volume, the pair indicating a pair relationship of the snapshot between the primary logical volume and the secondary logical volume, and first reference destination meta information indicating a reference destination of data stored in the secondary logical volume, and primary logical volume management information that manages correspondence between the identification information of the primary logical volume and second reference destination meta information indicating a reference destination of data stored in the primary logical volume, allocating the same family identification information that uniquely identifies a family to the primary logical volume and the secondary logical volume so that the primary logical volume and the secondary logical volume belong to the same family among families indicating groups of the logical volumes, allocating intra-family identification information that uniquely identifies the logical volumes within the same family to the first reference destination meta information and the second reference destination meta information, generating meta information management information that manages correspondence among the family identification information, the intra-family identification information, the first reference destination meta information and the second reference destination meta information, generating conversion information that manages correspondence among each of the identification information of the primary logical volume and the identification information of the secondary logical volume, the family identification information to which the primary logical volume and the secondary logical volume belong, and the intra-family identification information of the primary logical volume and the secondary logical volume, acquiring the corresponding family identification information and the corresponding intra-family identification information respectively from the identification information of the primary logical volume and the identification information of the secondary logical volume with reference to the conversion information in response to a request for access to the data stored in the primary logical volume and the secondary logical volume from the host apparatus, acquiring the first reference destination meta information and the second reference destination meta information respectively corresponding to the primary logical volume and the secondary logical volume with reference to the meta information management information based on the acquired family identification information and intra-family identification information, and accessing the data stored in the primary logical volume and the secondary logical volume based on the acquired first reference destination meta information and second reference destination meta information.

According to the present invention, it is possible to perform management operation of a Snapshot even between logical volumes to which a pair relationship cannot be provided in a storage system.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an explanatory diagram of outline of functions of a storage system according to an embodiment;

FIG. 2 is a configuration diagram of the storage system according to the embodiment;

FIG. 3 is a configuration diagram of a memory of the storage system according to the embodiment;

FIG. 4 is a configuration diagram of a pair management table according to the embodiment;

FIG. 5 is a configuration diagram of a PVOL management table according to the embodiment;

FIG. 6 is a configuration diagram of a Family meta information management table according to the embodiment;

FIG. 7 is a configuration diagram of an LDEV-to-Family conversion table according to the embodiment;

FIG. 8 is a sequence diagram indicating conversion processing from an SS before vClone support to an SS after vClone support according to the embodiment;

FIG. 9 is a flowchart indicating the conversion processing from the SS before vClone support to the SS after vClone support according to the embodiment;

FIG. 10A is schematic view of the conversion processing from the SS before vClone support to the SS after vClone support according to the embodiment;

FIG. 10B is a schematic view of the conversion processing from the SS before vClone support to the SS after vClone support according to the embodiment;

FIG. 10C is a schematic view of the conversion processing from the SS before vClone support to the SS after vClone support according to the embodiment;

FIG. 10D is a schematic view of the conversion processing from the SS before vClone support to the SS after vClone support according to the embodiment;

FIG. 11 is a sequence diagram indicating conversion processing from the SS after vClone support to a vClone according to the embodiment;

FIG. 12 is a schematic view of the conversion processing from the SS after vClone support to the vClone according to the embodiment;

FIG. 13 is a sequence diagram indicating conversion processing from the vClone to the SS after vClone support according to the embodiment;

FIG. 14 is a schematic view of the conversion processing from the vClone to the SS after vClone support according to the embodiment;

FIG. 15A is a view illustrating an input/output screen of conversion from the SS after vClone to the vClone according to the embodiment; and

FIG. 15B is a view illustrating an input/output screen of conversion from the vClone to the SS after vClone support according to the embodiment.

### DESCRIPTION OF EMBODIMENTS

An embodiment of the present invention will be described below with reference to the drawings. Note that the embodiment described below does not limit the invention according to the claims, and all elements described in the embodiment and combinations thereof are not necessarily essential for means for solution of the invention. Further, there is a case where illustration and description of components which are essential in the configuration of the invention but are well known may be omitted.

In the following description, while information obtained by an output with respect to an input may be described with an expression such as “Table xxx”, this information may be data having any structure. Thus, “Table xxx” can be referred to as “xxx information”.

Further, in the following description, a configuration of each table is one example, and one table may be divided into two or more tables, or all or part of two or more tables may be one table.

Further, in the following description, there is a case where processing may be described using a “program” as a subject. The program performs determined processing using a storage unit and/or a network interface, and the like, as appropriate by being executed by a processor unit. Thus, the subject of the processing may be the processor unit (or a device such as a controller including the processor unit).

The program may be installed in an apparatus such as a computer or, for example, may be in a program distribution server or a computer-readable (for example, non-transitory) recording medium. Further, in the following description, two or more programs may be implemented as one program, or one program may be implemented as two or more programs.

Further, the “processor unit” is one or more processors. The processor is typically a microprocessor such as a central processing unit (CPU) but may be other kinds of processors such as a graphics processing unit (GPU). Further, the processor may be a single core or may be a multicore. Still further, the processor may be a processor in a broad sense such as a hardware circuit (for example, a field-programmable gate array (FPGA) or an application specific integrated circuit (ASIC)) that performs part or all of the processing.

Further, in the following description, while identification numbers are used as identification information of various targets, identification information (for example, identifiers including alphabet characters and symbols) other than the identification numbers may be employed. In the following description, “#” represents a number, and, for example, “xxx #” represents xxx identified by the number.

Further, in the following description, in the case where elements of the same type are described without distinction, a reference numeral (or a common reference numeral among the reference numeral) is used, and in the case where elements of the same type are described while being distinguished, identification numbers (or reference numerals) of the elements are used. Further, the number of the respective elements illustrated in the respective drawings is one example and is not limited to the illustrated number.

### Outline of Functions of Storage System 201 According to Embodiment

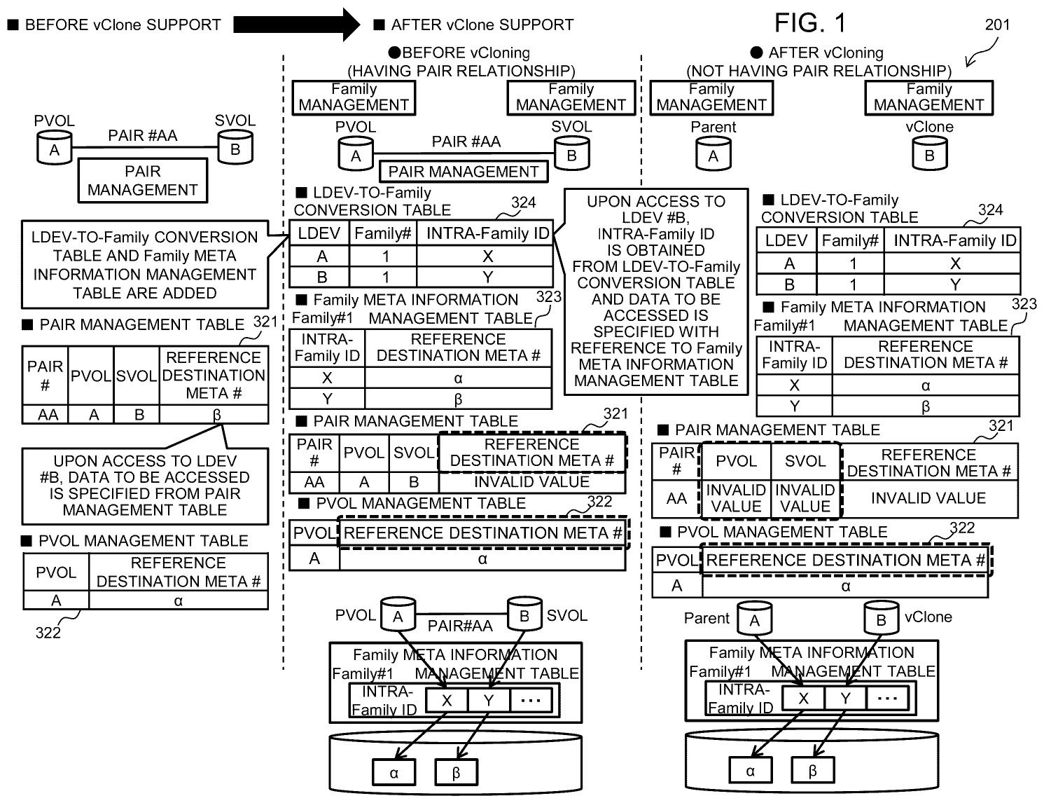

FIG. 1 is an explanatory diagram of outline of functions of a storage system 201 according to the embodiment. The storage system 201 has a function of creating a Snapshot that is a logical volume (hereinafter, abbreviated as an “LDEV”) which is a duplication of a logical volume. Further, the storage system 201 has a function of creating a virtual clone (vClone). The vClone is a secondary logical volume obtained by duplicating a primary logical volume created in a similar manner to the Snapshot. However, the vClone does not have a pair relationship of the primary logical volume and the secondary logical volume, and resources of metadata management are shared between the primary logical volume and the secondary logical volume.

The storage system 201 employs redirect-on-write (RoW) in which only metadata indicating a storage position of data is updated without copying the data by being triggered by acquisition of the Snapshot or write. In the ROW, a write area in which the LDEV or the data of the Snapshot is stored, and a meta information area in which meta information of the data written in the write area is stored are provided in a physical drive (a PDEV 220 which will be described later). The meta information includes a pair management table 321, a PVOL management table 322, a Family meta information management table 323 and an LDEV-to-Family conversion table 324 which will be described later.

As illustrated in FIG. 1, the storage system 201 has a state before vClone support and a state after vClone support.

Before the vClone support, a pair relationship between an LDEV #A which is a primary logical volume (PVOL) of the Snapshot in which the Row is employed and an LDEV #B which is a secondary logical volume (SVOL) is held in the pair management table 321. Upon access to the LDEV #B, meta information of data to be accessed is specified from “reference destination meta #” in the pair management table 321. Upon access to the LDEV #A, meta information of data to be accessed is specified from “reference destination meta #” in the PVOL management table 322.

On the other hand, after the vClone support, there are two states of before vCloning (having a pair relationship) and after vCloning (not having a pair relationship), and the states can transition to each other. In the case before vCloning (having a pair relationship), a relationship between a primary LDEV and a secondary LDEV is maintained. On the other hand, in the case after vCloning (note having a pair relationship), division and restoration can be performed between arbitrary LDEVs.

There are two methods for creating the vClone. The first method is a “(method 1) method of converting an already existing Snapshot having a pair relationship into a vClone”. The second method is a “(method 2) method of creating a vClone using an LDEV (not having a secondary logical volume in a pair relationship) in an SMPL state as a secondary LDEV”.

After the vClone support, the Family meta information management table 323 and the LDEV-to-Family conversion table 324 are added. A data reference destination of the LDEV is managed in units of “Family”. The “Family” is a group of LDEVs having a pair relationship of the PVOL and the SVOL before vCloning and, after vCloning, is a Parent and a vClone which have had the pair relationship of the PVOL and the SVOL before vCloning. The Parent is a PVOL which has had the pair relationship of the PVOL and the SVOL with respect to the corresponding vClone as the SVOL before vCloning.

The LDEV-to-Family conversion table 324 manages a Family #of the Family to which the LDEV belongs and an intra-Family ID indicating a data reference destination of the LDEV. The Family meta information management table 323 manages meta information of a reference destination for each intra-Family ID. The Family meta information management table 323 and the LDEV-to-Family conversion table 324 are generated based on information stored in the pair management table 321 and the PVOL management table 322.

Before vCloning after the vClone support, the intra-Family ID is obtained from the LDEV-to-Family conversion table 324 upon access to the LDEVs #A, #B. Then, meta information of data to be accessed is specified with reference to the Family meta information management table 323 based on the obtained intra-Family ID. Before vCloning, a reference destination meta #in the pair management table 321 and the PVOL management table 322 is invalidated. However, a pair relationship #AA between the PVOL and the SVOL in the pair management table 321 is maintained, and thus, a function similar to the Snapshot before the vClone support is provided.

After vCloning after the vClone support, a method for accessing the LDEVs #A, #B is similar to that before vCloning. On the other hand, the LDEV #A becomes a “Parent”, the LDEV #B becomes a “vClone”, and a pair relationship #AA between the PVOL and the SVOL in the pair management table 321 is invalidated. It is therefore possible to perform management operation even for the Snapshot for which generations are not consecutive, such as an LDEV #X3 and an LDEV #X1, the LDEV #X3 being obtained by duplicating an LDEV #X2 that is the duplicated LDEV of the LDEV #X1, and LDEVs #Y1, #Y2 that are two duplicated LDEVs of an LDEV #Y.

### Configuration of Computer System 100 According to Embodiment

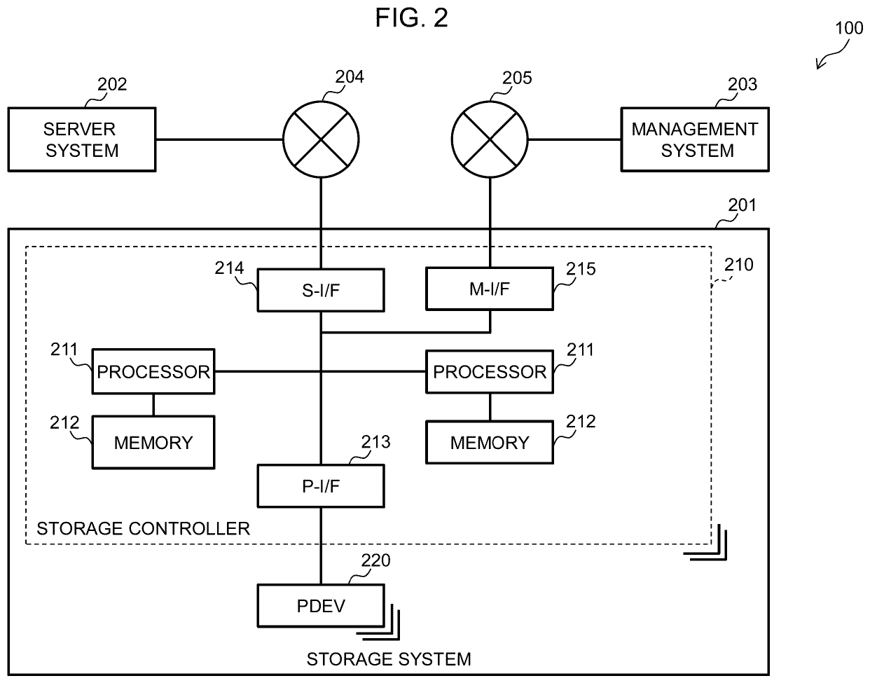

FIG. 2 is a configuration diagram of the computer system 100 according to the embodiment. The computer system 100 includes a storage system 201, a server system 202, and a management system 203. The storage system 201 and the server system 202 are connected via a fiber channel (FC) network 204. The storage system 201 and the management system 203 are connected via an Internet protocol (IP) network 205. Note that the FC network 204 and the IP network 205 may be the same communication network.

The storage system 201 includes a plurality of storage controllers 210, and a plurality of PDEVs 220. The PDEVs 220 are connected to the storage controller 210.

The storage controller 210 includes one or more processors 211, one or more memories 212, a P-I/F 213, an S-I/F 214, and an M-I/F 215.

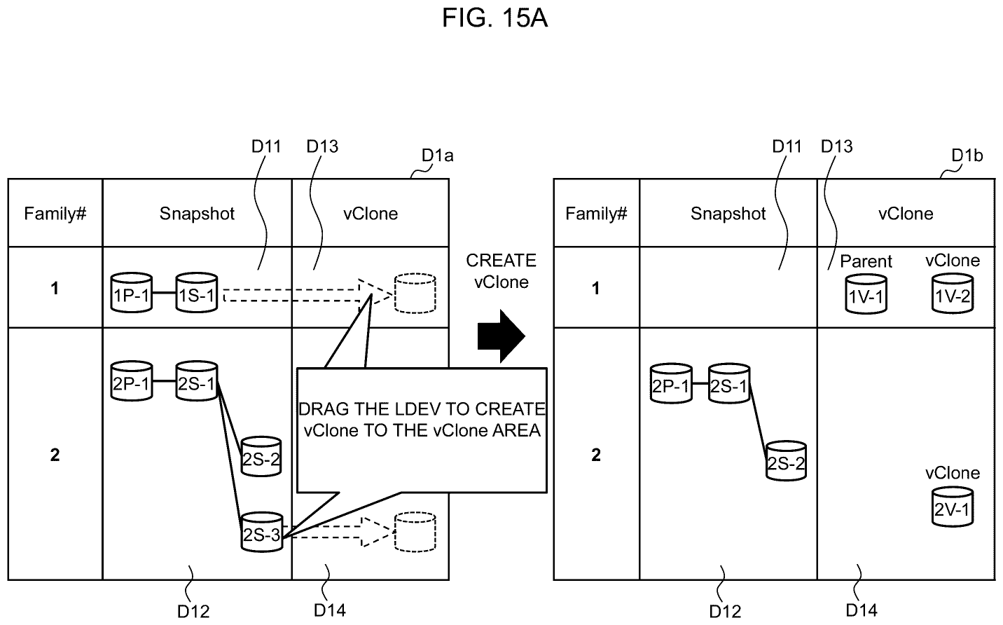

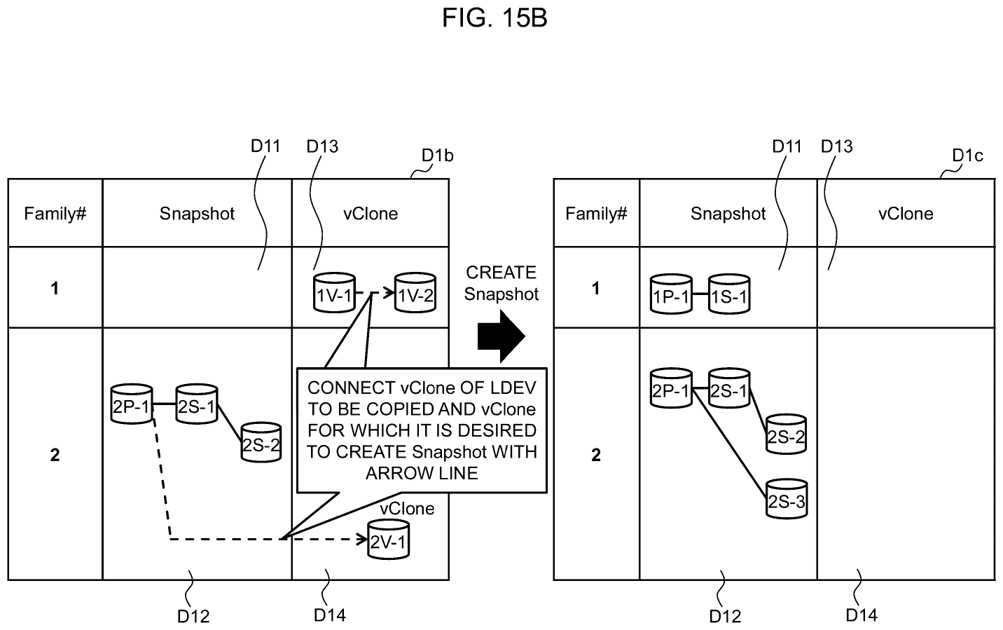

The processor 211 may include a hardware circuit. In the present embodiment, the processor 211 performs creation of a Snapshot, restoration, vClone support processing, vCloning processing, control related to input/output screens D1a, D1b, D1c (FIG. 15A and FIG. 15B), and the like, which will be described later.

The memory 212 is one example of a storage unit. The memory 212 stores a program to be executed by the processor 211, data, and the like, to be used by the processor 211. The processor 211 executes the program stored in the memory 212. Note that in the present embodiment, for example, the memory as a pair of the memory 212 and the processor 211, is duplicated.

The P-I/F 213, the S-I/F 214 and the M-I/F 215 are one example of an interface unit.

The P-I/F 213 is a communication interface device that mediates data exchange between the PDEV 220 and the storage controller 210. A plurality of the PDEVs 220 are connected to the P-I/F 213.

The S-I/F 214 is a communication interface device that mediates data exchange between the server system 202 and the storage controller 210. The server system 202 is connected to the S-I/F 214 via the FC network 204.

The M-I/F 215 is a communication interface device that mediates data exchange between the management system 203 and the storage controller 210. The management system 203 is connected to the M-I/F 215 via the IP network 205.

The server system 202 includes one or more host apparatuses. The server system 202 transmits an I/O request (a write request or a read request, or an access request) designating an I/O destination to the storage controller 210. The I/O destination is, for example, a logical volume number such as a logical unit number (LUN), a logical address such as a logical block address (LBA), or the like.

The management system 203 includes one or more management apparatuses. The management system 203 manages the storage system 201.

### Configuration of Memory 212 of Storage System 201 According to Embodiment

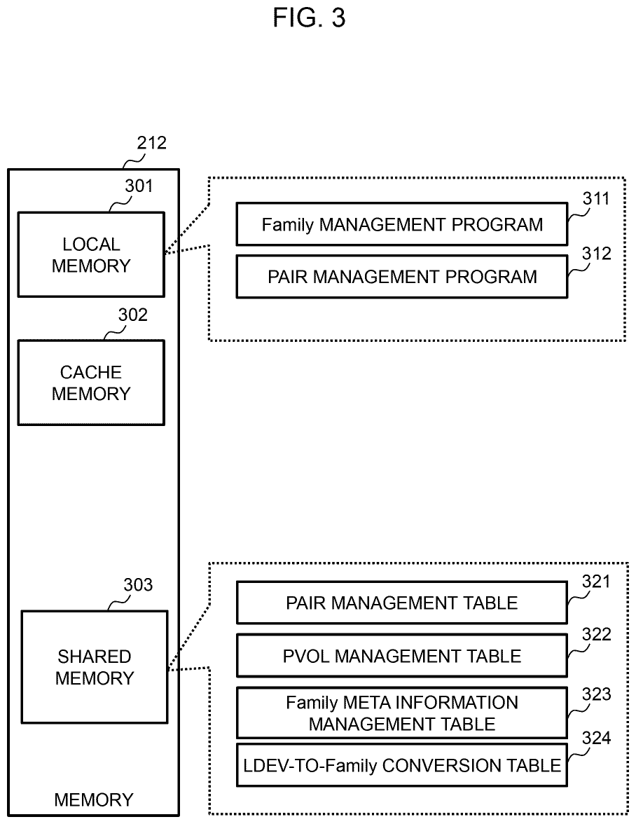

FIG. 3 is a configuration diagram of the memory 212 of the storage system 201 according to the embodiment. The memory 212 includes memory areas such as a local memory 301, a cache memory 302 and a shared memory 303. At least one of these memory areas may be an independent memory. The local memory 301 is used by the processor 211 belonging to the same pair as the memory 212 including the local memory 301.

In the local memory 301, a Family management program 311 and a pair management program 312 are stored as programs related to the present embodiment. Further, in the local memory 301, a volume creation program, a Snapshot creation program, a read program, a front-end write program, a back-end write program, a restoration program, and the like, are stored. These programs are provided for each of a plurality of storage controllers 210 and cooperate with each other to perform target processing. The Family management program 311 and the pair management program 312 will be described later.

In the cache memory 302, a dataset to be written or read with respect to the PDEV 220 is temporarily stored.

The shared memory 303 is used by both the processor 211 belonging to the same pair as the memory 212 including this shared memory 303 and the processor 211 belonging to a different pair. In the shared memory 303, the pair management table 321, the PVOL management table 322, the Family meta information management table 323 and the LDEV-to-Family conversion table 324 are stored. These tables will be described later with reference to the drawings. Further, in the shared memory 303, a volume management table, a directory area management table, a mapping area management table, a directory area allocation table, a mapping area allocation table, a Snapshot generation management table, and the like, are stored.

### Configuration of Pair Management Table 321 According to Embodiment

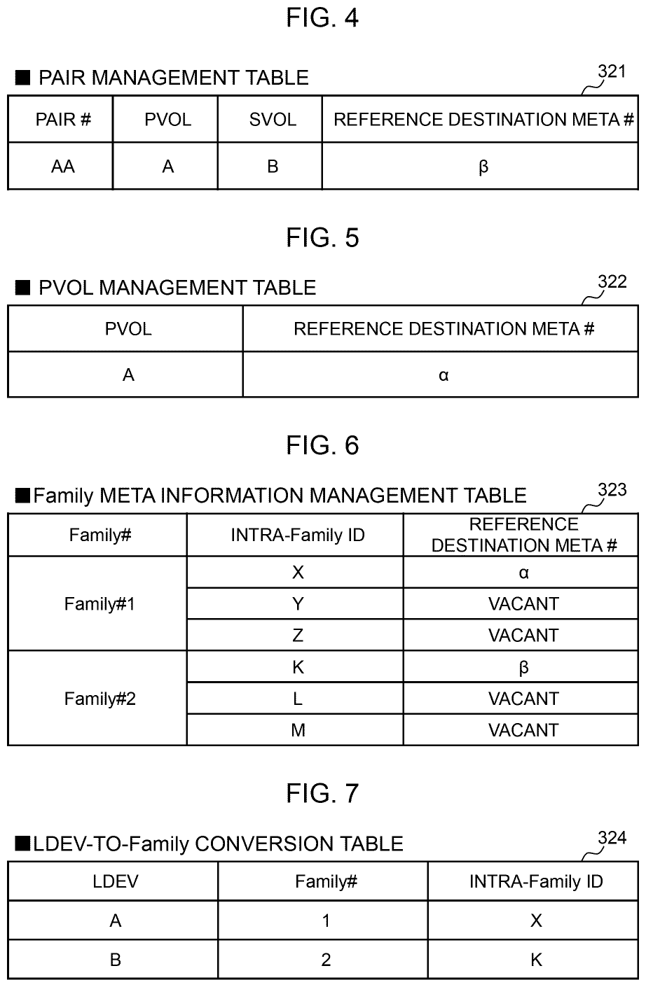

FIG. 4 is a configuration diagram of the pair management table 321 according to the embodiment. In the pair management table 321, specific information (reference destination meta #) of the meta information of the reference destination is managed for each pair of the PVOL that is the primary LDEV and the SVOL that is the secondary LDEV. The pair management table 321 is one example of pair management information. The reference destination meta #managed in the pair management table 321 is one example of first reference destination meta information.

### Configuration of PVOL Management Table 322 According to Embodiment

FIG. 5 is a configuration diagram of the PVOL management table 322 according to the embodiment. In the PVOL management table 322, specific information (such as reference destination information) of the meta information of the reference destination of the PVOL that is the primary LDEV is managed. The PVOL management table 322 is one example of primary logical volume management information. The reference destination meta # managed in the PVOL management table 322 is one example of second reference destination meta information.

### Configuration of Family Meta Information Management Table 323)

FIG. 6 is a configuration diagram of the Family meta information management table 323 according to the embodiment. In the Family meta information management table 323, the intra-Family ID that identifies the LDEV of the Family for each Family #, and reference destination information of the meta information of the LDEV having the corresponding intra-Family ID are managed. The Family meta information management table 323 is one example of meta information management information. The Family #is one example of family identification information. The intra-Family ID is intra-family identification information.

(Configuration of LDEV-to-Family conversion table 324 according to embodiment)

FIG. 7 is a configuration diagram of the LDEV-to-Family conversion table 324 according to the embodiment. In the LDEV-to-Family conversion table 324, the Family # of the Family to which the LDEV belongs, and the intra-Family ID are managed for each LDEV. The LDEV-to-Family conversion table 324 is one example of conversion information.

Conversion processing from SS Before vClone Support to SS after vClone Support According to Embodiment

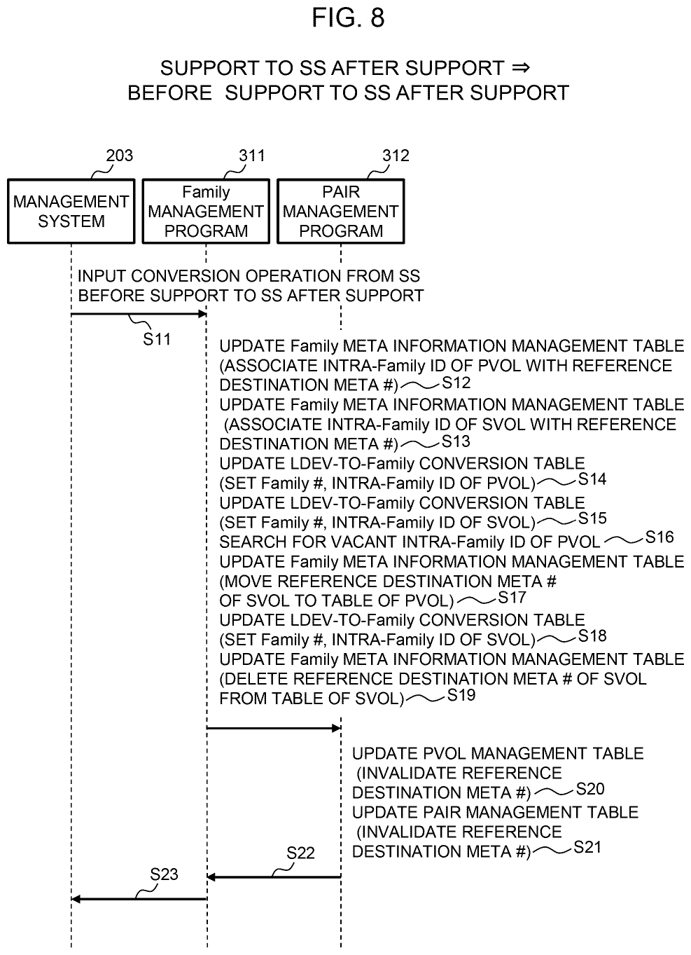

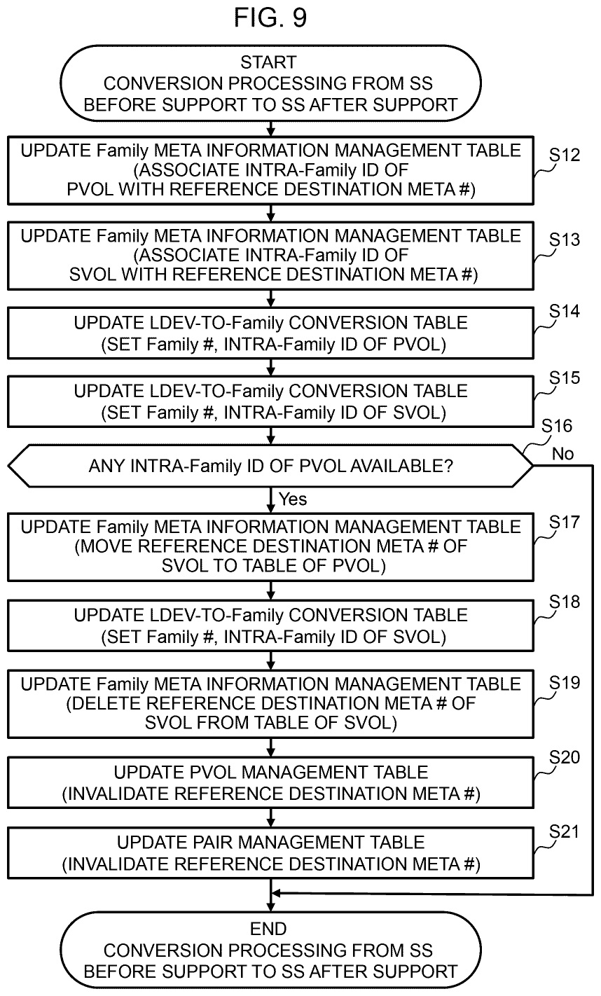

FIG. 8 is a sequence diagram indicating conversion processing from the SS before vClone support to the SS after vClone support according to the embodiment. FIG. 9 is a flowchart indicating conversion processing from the SS before vClone support to the SS after vClone support according to the embodiment. The conversion processing from the SS before vClone support to the SS after vClone support is processing of converting the SS (Snapshot) from the SS before vClone support illustrated in FIG. 1 to the SS after vClone support. The same step numbers in FIG. 8 and FIG. 9 indicate the same processing.

First, FIG. 8 is referred to. In step S11, the management system 203 accepts conversion operation from the SS before support to the SS after support while the LDEV is designated by the user via a terminal (not illustrated) and outputs the conversion operation to the Family management program 311.

Then, the Family management program 311 executes processing from step S12 to S19 in accordance with input of the conversion operation from the SS before support to the SS after support from the management system 203. Then, the pair management program 312 executes processing from step S20 to S21 in response to end of the processing in step S19. Then, in step S22, the pair management program 312 notifies the Family management program 311 of completion of the processing. Then, in step S23, the Family management program 311 notifies the management system 203 of completion of the processing.

FIG. 9 is referred to next. In step S12, the Family management program 311 associates the intra-Family ID of the PVOL with the reference destination meta #to update the Family meta information management table 323. Then, in step S13, the Family management program 311 associates the intra-Family ID of the SVOL with the reference destination meta #to update the Family meta information management table 323.

Then, in step S14, the Family management program 311 sets the Family #and the intra-Family ID of the PVOL to update the LDEV-to-Family conversion table 324. Then, in step S15, the Family management program 311 sets the Family #and the intra-Family ID of the SVOL to update the LDEV-to-Family conversion table 324.

Then, in step S16, the Family management program 311 searches for an available intra-Family ID of the PVOL, and in the case where there is an available intra-Family ID, the processing transitions to step S17, and in the case where there is no available intra-Family ID, the flowchart in FIG. 9 ends.

In step S17, the Family management program 311 moves the reference destination meta #of the SVOL to the table of the PVOL to update the Family meta information management table 323. Then, in step S18, the Family management program 311 sets the Family #and the intra-Family ID of the SVOL to update the LDEV-to-Family conversion table 324. Then, in step S19, the Family management program 311 deletes the reference destination meta #of the SVOL from the table of the SVOL to update the Family meta information management table 323.

Then, in step S20, the pair management program 312 invalidates the reference destination meta #to update the PVOL management table 322. Then, in step S21, the pair management program 312 invalidates the reference destination meta #to update the pair management table 321. If the processing in step S21 ends, the flowchart in FIG. 9 ends.

Outline of Conversion Processing From SS Before vClone Support to SS After vClone Support According to Embodiment

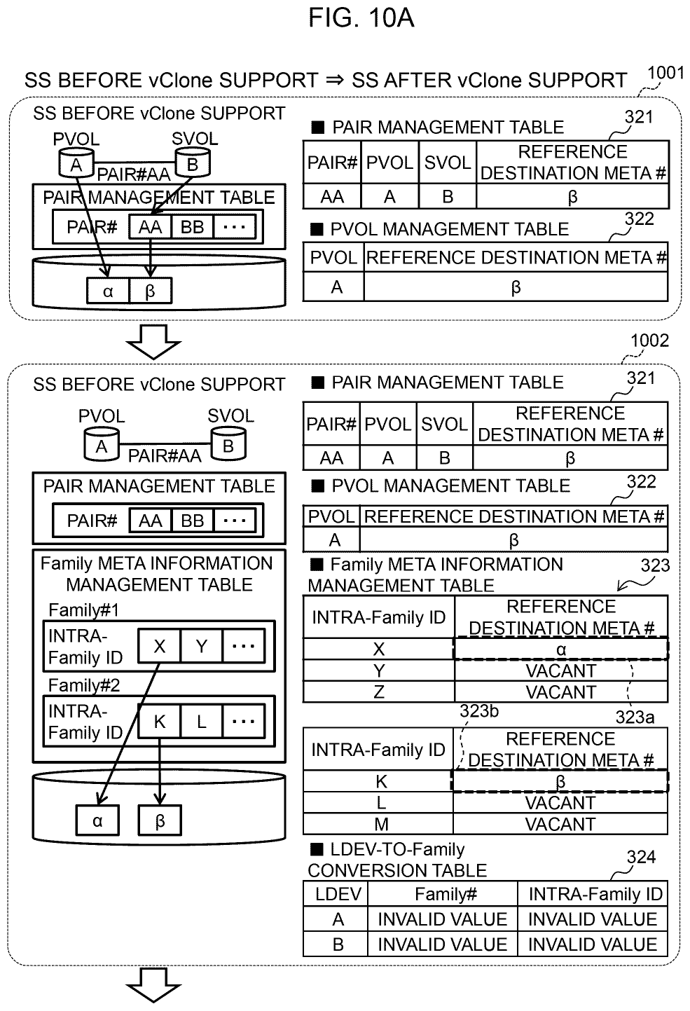

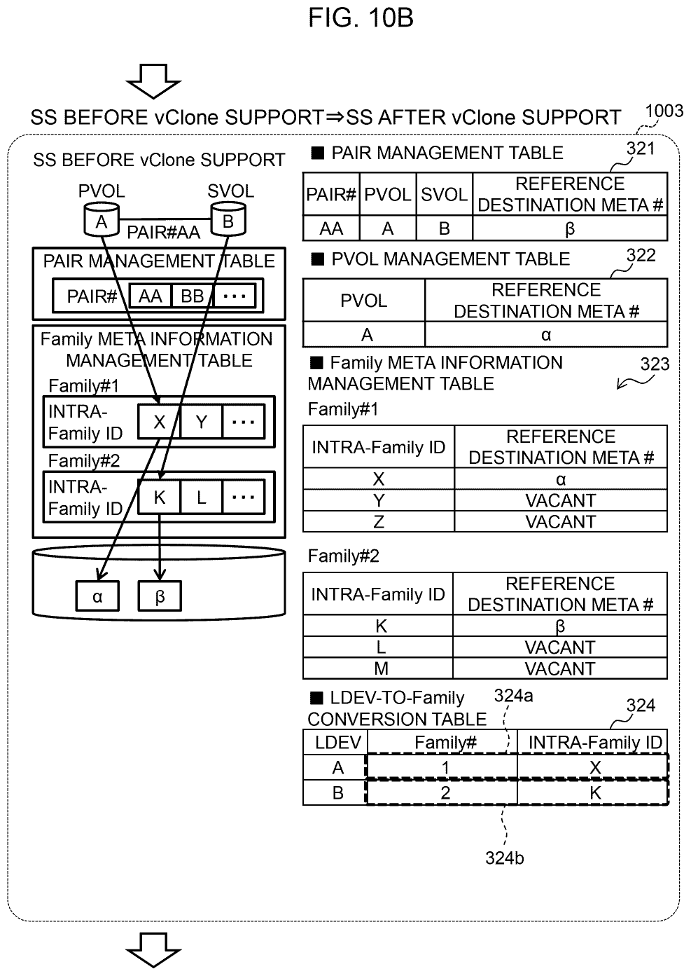

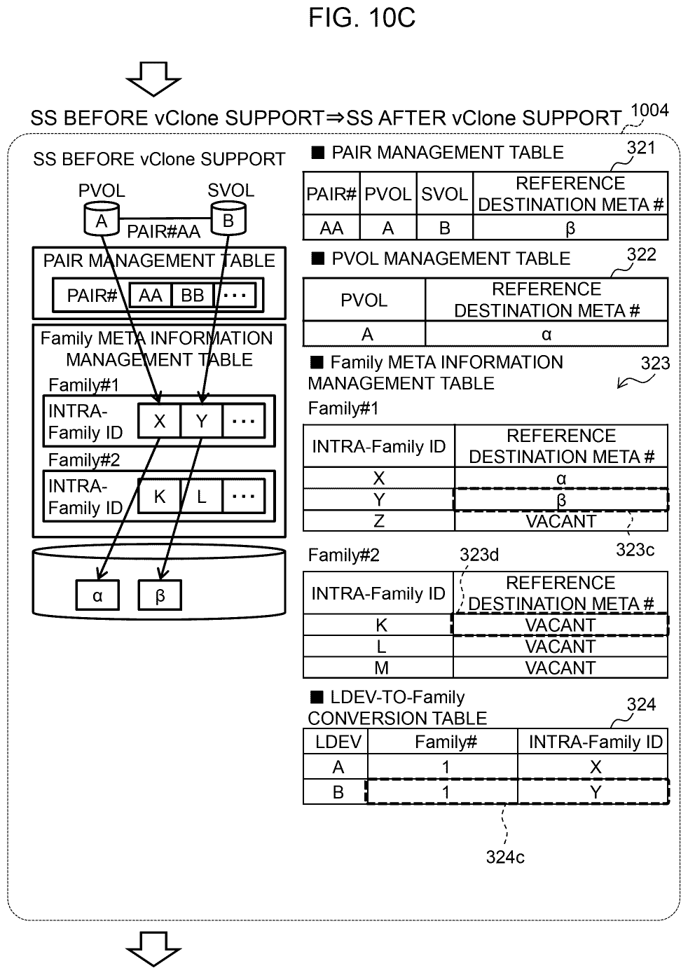

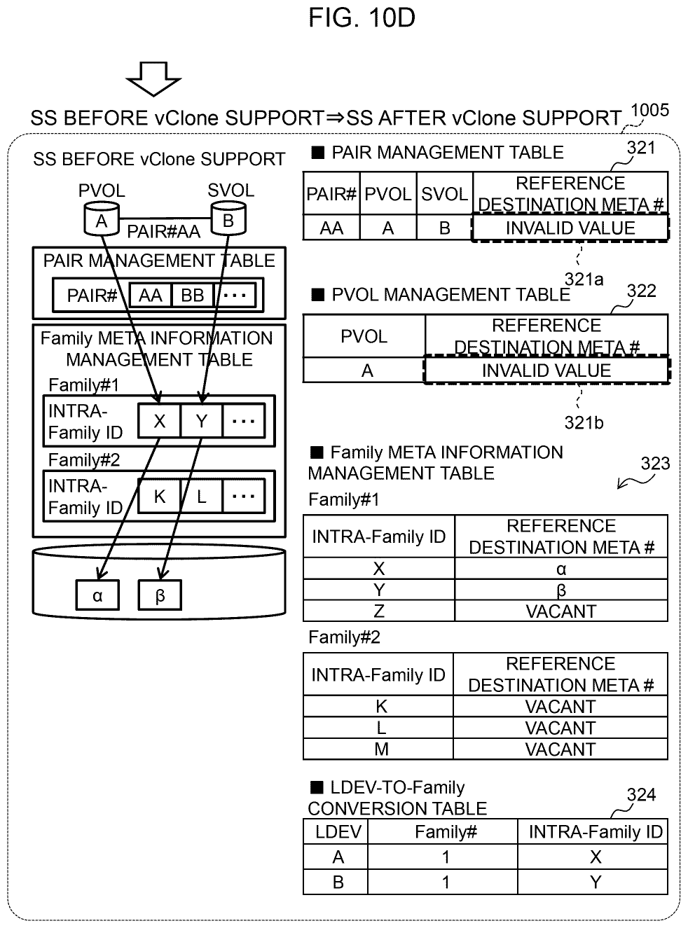

Outline of the conversion processing from the SS before vClone support to the SS after vClone support described in FIG. 8 to FIG. 9 will be described with reference to FIG. 10A to FIG. 10D. FIG. 10A to FIG. 10D are schematic views of the conversion processing from the SS before vClone support to the SS after vClone support according to the embodiment.

First, FIG. 10A is referred to. A state 1001 in FIG. 10A indicates a state before the processing in step S11 in FIG. 8 is executed. In the state 1001, the LDEV #A that is the PVOL and the LDEV #B that is the SVOL have a pair relationship. The LDEV #A that is the PVOL refers to a reference destination meta #a of the PDEV 220 based on the PVOL management table 322. The LDEV #B that is the SVOL refers to a reference destination meta #of the PDEV 220 based on the pair management table 321.

A state 1002 in FIG. 10A indicates a state when the processing in step S12 and S13 in FIG. 8 is executed. In the state 1002, a pair relationship between the LDEV #A that is the PVOL and the LDEV #B that is the SVOL is still maintained. Operation 323a corresponds to step S12 in FIG. 8, and the reference destination meta #α is associated with the intra-Family ID “X” of the Family #1 in the Family meta information management table 323. Operation 323b corresponds to step S13 in FIG. 8, and the reference destination meta #β is associated with the intra-Family ID “K” of the Family #2 in the Family meta information management table 323.

Then, FIG. 10B is referred to. A state 1003 in FIG. 10B indicates a state when the processing in step S14 and S15 in FIG. 8 is executed. In the state 1003, the pair relationship between the LDEV #A that is the PVOL and the LDEV #B that is the SVOL is still maintained. Operation 324a corresponds to step S14 in FIG. 8, and the Family # “1” and the intra-Family ID “X” are associated with the LDEV #A in the LDEV-to-Family conversion table 324. Operation 324b corresponds to step S15 in FIG. 8, and the Family # “2” and the intra-Family ID “K” are associated with the LDEV #B in the LDEV-to-Family conversion table 324.

A state 1004 in FIG. 10C indicates a state where the processing in step S17, S18 and S19 is executed in the case where there is an available intra-Family ID of the PVOL in step S16 in FIG. 8. In the state 1004, the pair relationship between the LDEV #A that is the PVOL and the LDEV #B that is the SVOL is still maintained. Operation 323c corresponds to step S17 in FIG. 8. In operation 323c, the reference destination meta # “β” having the intra-Family ID “K” of the Family #2 is moved so as to be associated with the reference destination meta #having the intra-Family ID “Y” of the Family #1 in the Family meta information management table 323. Operation 324c corresponds to step S18 in FIG. 8, and the LDEV-to-Family conversion table 324 is updated so that the Family # “1” and the intra-Family ID “Y” are associated with the LDEV #B. Operation 323d corresponds to step S19 in FIG. 8, and the reference destination meta #associated with the intra-Family ID “K” of the Family #2 is deleted to be “available” in the Family meta information management table 323.

Then, FIG. 10D is referred to. A state 1005 in FIG. 10D indicates a state when the processing in step S20 and S21 in FIG. 8 is executed. In the state 1005, the pair relationship between the LDEV #A that is the PVOL and the LDEV #B that is the SVOL is still maintained. Operation 321a corresponds to step S20 in FIG. 8, and the reference destination meta #corresponding to the pair #AA is invalidated in the pair management table 321. Operation 321b corresponds to step S21 in FIG. 8, and the reference destination meta #corresponding to the PVOL #A is invalidated in the PVOL management table 322. In the state 1005, the LDEV #A and the LDEV #B indicate a Snapshot for which the vClone is supported and can transition to the vClone at an arbitrary timing.

Conversion Processing From SS After vClone Support to vClone According to Embodiment

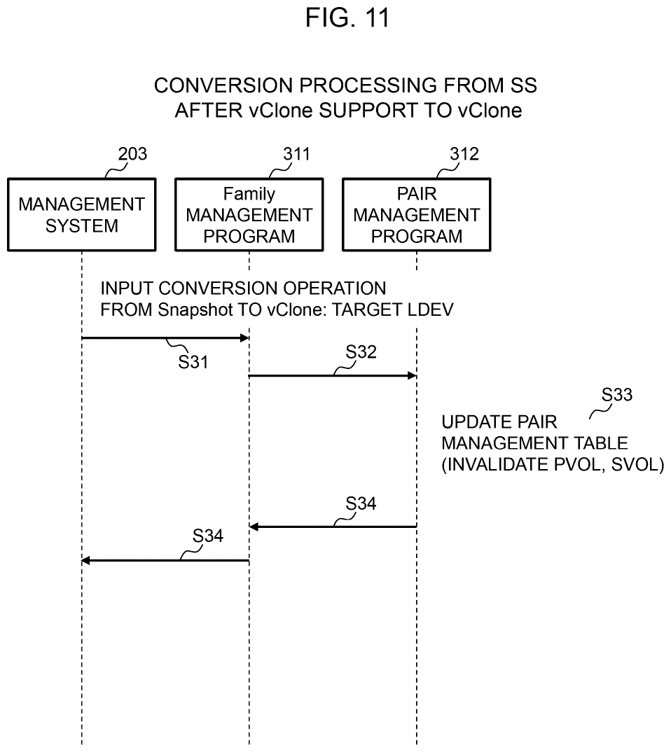

FIG. 11 is a sequence diagram indicating conversion processing from the SS after vClone support to the vClone according to the embodiment. The conversion processing from the SS after vClone support to the vClone is processing of converting the state from the SS before vCloning to the vClone, after vClone support illustrated in FIG. 1.

First, in step S31, the management system 203 accepts conversion operation from the SS after vClone support to the vClone while the LDEV is designated by the user via a terminal (not illustrated) and outputs the conversion operation to the Family management program 311.

Then, in step S32, the Family management program 311 outputs the conversion operation from the SS after vClone support to the vClone received from the management system 203 to the pair management program 312. In step S33, the pair management program 312 invalidates the PVOL and the SVOL in the pair management table 321 in response to the conversion operation from the SS after vClone support to the vClone. Then, in step S34, the pair management program 312 notifies the Family management program 311 of completion of processing. Then, in step S35, the Family management program 311 notifies the management system 203 of completion of the processing.

Outline of Conversion Processing From SS After vClone Support to vClone According to Embodiment

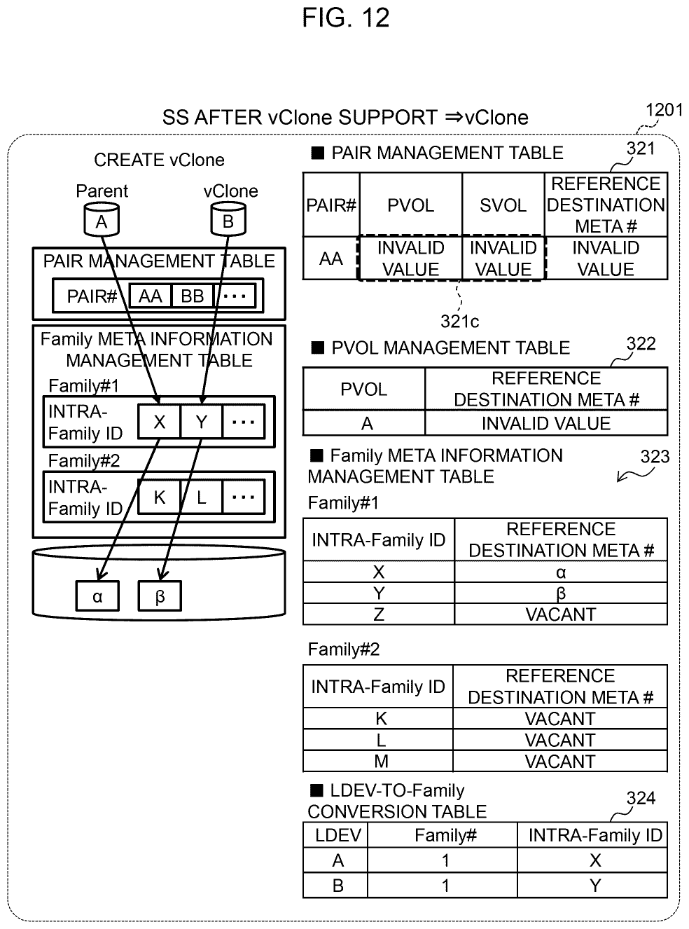

Outline of the conversion processing from the SS after vClone support to the vClone described in FIG. 11 will be described with reference to FIG. 12. FIG. 12 is a schematic view of the conversion processing from the SS after vClone support to the vClone according to the embodiment.

A state one state before a state 1201 in FIG. 12 is a state before the processing in step S31 in FIG. 11 is executed and is the state 1005 in FIG. 10D.

The state 1201 in FIG. 12 indicates a state when the processing in step S33 in FIG. 11 is executed. Operation 321c corresponds to step S33 in FIG. 11, and invalid values are set to the PVOL and the SVOL in the pair management table 321. Thus, in the state 1201, the pair relationship between the LDEV #A that is the PVOL and the LDEV #B that is the SVOL is dissolved.

A conversion method of the vClone indicated in FIG. 12 through FIG. 10A to FIG. 10D corresponds to the above-described “(method 1) method of converting the already existing Snapshot having a pair relationship to the vClone”. Further, setting respective setting values to the pair management table 321, the PVOL management table 322, the Family meta information management table 323, and the LDEV-to-Family conversion table 324 from the beginning as indicated in FIG. 12 corresponds to the above-described (method 2).

Conversion Processing From vClone to SS After vClone Support According to Embodiment

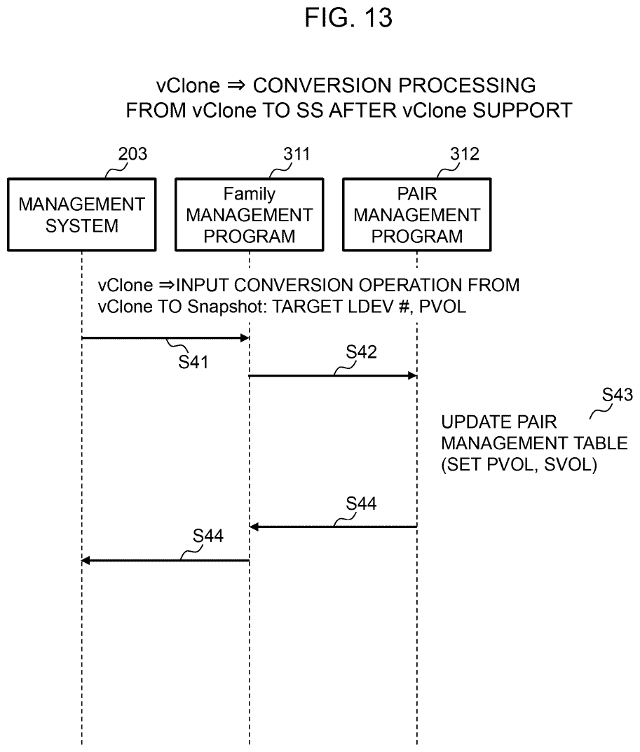

FIG. 13 is a sequence diagram indicating the conversion processing from the vClone to the SS after vClone support according to the embodiment. The conversion processing from the vClone to the SS after vClone support is processing of converting the state from the vClone to the SS before vClone support, after the vClone support illustrated in FIG. 1.

First, in step S41, the management system 203 accepts conversion operation from the vClone to the SS after vClone support while the LDEV is designated by the user via a terminal (not illustrated) and outputs the conversion operation to the Family management program 311.

Then, in step S42, the Family management program 311 outputs the conversion operation from the vClone to the SS after vClone support received from the management system 203 to the pair management program 312. In step S43, the pair management program 312 sets the PVOL and the SVOL in the pair management table 321 in response to the conversion operation from the vClone to the SS after vClone support. Then, in step S44, the pair management program 312 notifies the Family management program 311 of completion of the processing. Then, in step S45, the Family management program 311 notifies the management system 203 of completion of the processing.

Outline of Conversion Processing From vClone to SS After vClone Support According to Embodiment

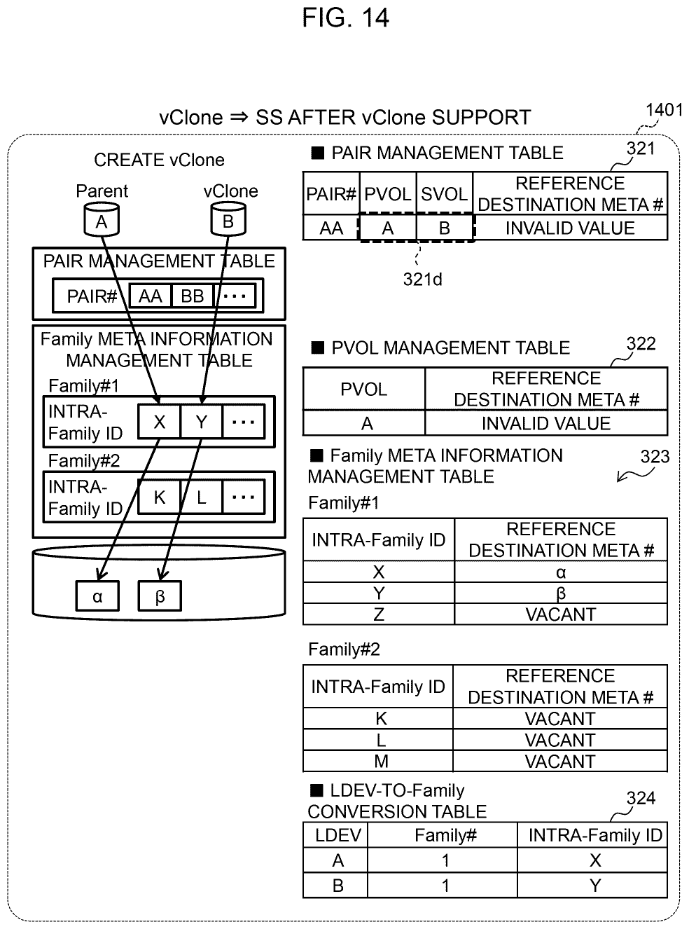

Outline of the conversion processing from the vClone to the SS after vClone support described in FIG. 13 will be described with reference to FIG. 14. FIG. 14 is a schematic view of the conversion processing from the vClone to the SS after vClone support according to the embodiment.

A state one state before a state 1401 in FIG. 14 is a state before the processing in step S41 in FIG. 13 is executed and is the state 1201 in FIG. 12.

The state 1401 in FIG. 14 indicates a state when the processing in step S43 in FIG. 13 is executed. Operation 321d corresponds to step S43 in FIG. 13, and respective values are set to the PVOL and the SVOL in the pair management table 321. The values are arbitrarily set by the user. Note that the values are not limited to the values that are arbitrarily set by the user, and the LDEV # “A” to be set as the PVOL in the pair management table 321 may be acquired from the PVOL management table 322. In a similar manner, the LDEV # “B” to be set as the SVOL in the pair management table 321 may be acquired from the LDEV #B that is the same Family #as the LDEV #A with reference to the LDEV-to-Family conversion table 324. As a result, in the state 1401, the pair relationship between the LDEV #A that is the PVOL and the LDEV #B that is the SVOL is restored.

### Input/Output Screens D1a, D1b and D1c According to Embodiment

Input/output screens D1a, D1b and D1c according to the embodiment displayed at a display apparatus (not illustrated), or the like, of the management system 203 will be described with reference to FIG. 15A and FIG. 15B. In the input/output screens D1a, D1b and D1c, it is assumed that the conversion processing from the SS before vClone support to the SS after vClone support (FIG. 8 to FIG. 9) has been executed, and Family management of the LDEV has been introduced.

The user can input an instruction to execute the conversion processing from the SS after vClone support to the vClone and the conversion processing from the vClone to the SS after vClone support to the storage system 201 by operating the input/output screens D1a to D1c with an input device such as a keyboard and a mouse.

FIG. 15A is a view illustrating the input/output screens D1a and D1b of conversion from the SS after vClone support to the vClone according to the embodiment. FIG. 15B is a view illustrating the input/output screens D1b and D1c of conversion from the vClone to the SS after vClone support according to the embodiment. The input/output screen D1b is the same between FIG. 15A and FIG. 15B.

First, FIG. 15A is referred to. As illustrated in the input/output screen D1a, the Family #1 includes a pair of the Snapshot between an LDEV #1P-1 and an LDEV #1S-1 displayed in a Snapshot area D11. Further, the Family #2 includes a pair of the Snapshot between an LDEV #2P-1 and an LDEV #2S-1 displayed in a Snapshot area D12. In a similar manner, the Family #2 includes a pair of the Snapshot between the LDEV #2S-1 and an LDEV #2S-2, and a pair of the Snapshot between the LDEV #2S-1 and an LDEV #2S-3 displayed in the Snapshot area D12. The Snapshot area D11 is one example of a first area.

For example, a case of vCloning the LDEV #1S-1 of the Family #1 will be considered. The LDEV #1S-1 is dragged to a vClone area D13 on the input/output screen D1a. Then, the conversion processing from the SS after vClone support to the vClone (FIG. 11) is executed in the storage system 201. Then, as displayed on the input/output screen D1b, a pair of the Snapshot between the LDEV #1P-1 and the LDEV #1S-1 of the Family #1 is dissolved. Then, a combination of Parent-vClone of an LDEV #1V-1 and an LDEV #1V-2 displayed in the vClone area D13 is made. The Clone area D13 is one example of a second area.

Further, for example, a case of vCloning the LDEV #2S-3 of the Family #2 will be considered. The LDEV #2S-3 is dragged to a vClone area D14 on the input/output screen D1a. Then, the conversion processing from the SS after vClone support to the vClone (FIG. 11) is executed in the storage system 201. Then, as displayed on the input/output screen D1b, a pair of the Snapshot between the LDEV #2S-1 and the LDEV #2S-3 of the Family #2 is dissolved, a vClone of the LDEV #2V-1 displayed in the vClone area D14 is generated.

However, while the pair relationship of the Snapshot between the LDEV #2S-1 which has had a pair relationship with the LDEV #2S-3, and the LDEV #2S-3 is dissolved, a pair relationship of the Snapshot between the LDEV #2S-1 and the LDEV #2P-1 and a pair relationship of the Snapshot between the LDEV #2S-1 and the LDEV #2S-2 are still maintained. Thus, the LDEV #2S-1 stays in the Snapshot area D12. The Snapshot area D12 is one example of the first area. The vClone area D14 is one example of the second area.

Then, FIG. 15B is referred to. For example, a case of creating a Snapshot of the LDEV #1V-1 and the LDEV #1V-2 of the Family #1 will be considered. The LDEV #1V-1 and the LDEV #1V-2 are connected with an arrow line from the LDEV #1V-1 toward the LDEV #1V-2 on the input/output screen D1b. Then, the conversion processing from the vClone to the SS after vClone support (FIG. 13) is executed in the storage system 201. Then, as displayed on the input/output screen D1c, a pair of the Snapshot between the LDEV #1V-1 as the PVOL and the LDEV #1V-2 as the SVOL of the Family #1 is established. Then, a pair of the Snapshot between the LDEV #1P-1 and the LDEV #1S-2 displayed in the Snapshot area D11 is established. The pair of the Snapshot between the LDEV #1P-1 and the LDEV #1S-2 is established, and if a restoration button (not illustrated) on the input/output screen D1c is depressed in a state where this pair is selected, the LDEV #1P-1 is restored from the LDEV #1S-2.

Further, for example, a case of creating a Snapshot so that the LDEV #2V-1 and the LDEV #2P-1 of the Family #2 are paired will be considered. The LDEV #2P-1 and the LDEV #2V-1 are connected with an arrow line from the LDEV #2P-1 toward the LDEV #2V-1 on the input/output screen D1b. Then, the conversion processing from the vClone to the SS after vClone support (FIG. 13) is executed in the storage system 201. Then, as displayed on the input/output screen D1c, a pair of the Snapshot between the LDEV #2P-1 as the PVOL and the LDEV #2V-1 as the SVOL of the Family #2 is established. Then, a pair of the Snapshot between the LDEV #2P-1 and the LDEV #2S-3 displayed in the Snapshot area D12 is established. A pair of the Snapshot between the LDEV #2P-1 and the LDEV #2S-3 is established, and if a restoration button (not illustrated) on the input/output screen D1c is depressed in a state where this pair is selected, the LDEV #2P-1 is restored from the LDEV #2S-3.

Note that there is a restriction that there is one PVOL for the SVOL when creating a Snapshot of the LDEV of the vClone. Thus, in the example of the input/output screen D1b, when a Snapshot of the LDEV #2V-1 is created, there are a case where the LDEV #2S-1 is set as the PVOL, and the LDEV #2V-1 is set as the SVOL, and a case where the LDEV #2S-2 is set as the PVOL, and the LDEV #2V-1 is set as the SVOL other than a case where the LDEV #2P-1 is set as the PVOL, and the LDEV #2V-1 is set as the SVOL. However, in cases other than these cases, a Snapshot of the LDEV cannot be created because such cases correspond to the above-described restriction.

### Effects of Embodiment

In the above-described embodiment, the conversion processing from before vClone support to after vClone support is performed, and data access not depending on the pair management table 321 and the PVOL management table 322 is achieved while maintaining a pair relationship between the primary LDEV and the secondary LDEV. It is therefore possible to dissolve a pair relationship through simple processing as necessary to create a vClone that is the secondary LDEV.

Further, in the above-described embodiment, after vClone support, the primary LDEV can be restored from the secondary LDEV in a similar manner to before the vClone support.

Further, in the above-described embodiment, the conversion processing from before vCloning after the vClone support (having a pair relationship) to after the vCloning (not having a pair relationship) is performed. This vCloning enables construction of coordination with other remote copy and local copy which cannot be constructed as the SVOL. Further, the vClone shares resources with the primary LDEV, so that it is possible to perform operation of high-speed pair division and restoration by metadata copy between the LDEVs that share resources of the same duplication source.

Further, in the above-described embodiment, the conversion processing from after the vCloning (not having a pair relationship) to before the vCloning (having a pair relationship) is performed. By creating the Snapshot in this manner, it is possible to construct a snapshot configuration of the primary LDEV and the secondary LDEV with a high degree of freedom.

Further, in the above-described embodiment, an instruction to execute processing by intuitive operation by the user can be accepted using a GUI (input/output screen D1a, D1b, D1c) illustrated in FIG. 15A and FIG. 15B. The processing described here refers to conversion processing from before the vCloning after the vClone support (having a pair relationship) to after the vCloning (not having a pair relationship), and conversion processing from after the vCloning after the vClone support (not having a pair relationship) to before the vCloning (having a pair relationship).

Further, in the above-described embodiment, upon generation of the Family meta information management table 323 and the LDEV-to-Family conversion table 324, after different Family #are provided to two LDEVs once, the same Family #is provided again. For example, by reserving the Family #provided once, the reserved Family #can be reused upon reconfiguration of the Family later, so that the degree of freedom of the reconfiguration of the Family after vCloning is improved.

Although the present disclosure has been described with reference to example embodiments, those skilled in the art will recognize that various changes and modifications may be made in form and detail without departing from the spirit and scope of the claimed subject matter.

Further, the above-described embodiment is provided to describe the present invention in detail to facilitate understanding and does not necessarily limit the present invention to one including all the described components. In addition, it is also possible to replace and add components as well as deletion of the components. Further, an embodiment combining part or all of the above-described embodiment as appropriate so as to be consistent is also included in the embodiment of the present invention.

Further, part or all of the respective components, functions, processing units, processing means, and the like, described above may be implemented by hardware by, for example, being designed with an integrated circuit. Further, the present invention can be also implemented by a program code of software that implements the functions of the embodiment. In this case, a recording medium recording the program code is provided to a computer, and a processor of the computer reads the program code stored in the recording medium.

In this case, the program code itself read from the recording medium implements the functions of the embodiment described above, and the program code itself and the recording medium storing the program code constitute the present invention. As the recording medium for supplying such a program code, for example, a flexible disk, a CD-ROM, a DVD-ROM, a hard disk, a solid state drive (SSD), an optical disk, a magnetooptical disk, a CD-R, a magnetic tape, a non-volatile memory card, a ROM, or the like, is used.

Further, the program code that implements the functions described in the present embodiment can be implemented with a wide range of programs or script languages, for example, assembler, C/C++, perl Shell, PHP, and Java (registered trademark).

In the above-described embodiment, only control lines and information lines considered to be necessary for description are illustrated, and not all the control lines and information lines of a product are necessarily illustrated. All components may be connected to each other.

What is claimed is:

1. A storage system comprising a storage controller which provides a plurality of logical volumes to a host apparatus and which is capable of creating a snapshot as a secondary logical volume that is a duplication of a primary logical volume,
the storage controller
managing respective pieces of information of:
pair management information that manages correspondence between a pair of identification information of the primary logical volume and identification information of the secondary logical volume, the pair indicating a pair relationship of the snapshot between the primary logical volume and the secondary logical volume, and first reference destination meta information indicating a reference destination of data stored in the secondary logical volume; and
primary logical volume management information that manages correspondence between the identification information of the primary logical volume and second reference destination meta information indicating a reference destination of data stored in the primary logical volume;
allocating the same family identification information that uniquely identifies a family to the primary logical volume and the secondary logical volume so that the primary logical volume and the secondary logical volume belong to the same family among families indicating groups of the logical volumes;
allocating intra-family identification information that uniquely identifies the logical volumes within the same family to the first reference destination meta information and the second reference destination meta information;
generating meta information management information that manages correspondence among the family identification information, the intra-family identification information, the first reference destination meta information and the second reference destination meta information;
generating conversion information that manages correspondence among each of the identification information of the primary logical volume and the identification information of the secondary logical volume, the family identification information to which the primary logical volume and the secondary logical volume belong, and the intra-family identification information of the primary logical volume and the secondary logical volume;
acquiring the corresponding family identification information and the corresponding intra-family identification information from the identification information of the primary logical volume and the identification information of the secondary logical volume with reference to the conversion information in response to a request for access to the data stored in the primary logical volume and the secondary logical volume from the host apparatus;
acquiring the first reference destination meta information and the second reference destination meta information respectively corresponding to the primary logical volume and the secondary logical volume with reference to the meta information management information based on the acquired family identification information and intra-family identification information; and
accessing the data stored in the primary logical volume and the secondary logical volume based on the acquired first reference destination meta information and second reference destination meta information.

2. The storage system according to claim 1,
wherein the storage controller restores the primary logical volume from the secondary logical volume once an instruction to restore the primary logical volume is accepted.

3. The storage system according to claim 1,
wherein the storage controller invalidates the identification information of the primary logical volume and the identification information of the secondary logical volume to invalidate the pair relationship of the primary logical volume and the secondary logical volume in the pair management information.

4. The storage system according to claim 3,
wherein the storage controller validates the pair relationship between arbitrary logical volumes by setting the identification information of the arbitrary logical volumes to the identification information of the primary logical volume and the identification information of the secondary logical volume in the pair management information.

5. The storage system according to claim 4,
wherein the storage controller
displays a pair of the primary logical volume and the secondary logical volume for which the pair relationship is validated for each of the groups in a first area of an input/output screen;
accepts selection of the secondary logical volume between the primary logical volume and the secondary logical volume in the input/output screen;
invalidates the pair relationship by setting invalid values to the identification information of the secondary logical volume for which selection is accepted, and the identification information of the primary logical volume for which the pair relationship with the secondary logical volume is validated, in the pair management information; and
moves the pair of the primary logical volume and the secondary logical volume for which the pair relationship is invalidated to a second area of the input/output screen and displays the pair.

6. The storage system according to claim 5,
wherein the storage controller
accepts selection of arbitrary two logical volumes in the input/output screen;
invalidates the pair relationship between the arbitrary two logical volumes by setting identification information of the arbitrary two logical volumes to the identification information of the primary logical volume and the identification information of the secondary logical volume in the pair management information; and
moves the logical volumes for which the pair relationship is validated to the first area and displays the pair.

7. The storage system according to claim 1,
wherein the storage controller
provides different pieces of the family identification information to the primary logical volume and the secondary logical volume;
generates the meta information management information and the conversion information by allocating the different pieces of the family identification information to the first reference destination meta information and the second reference destination meta information;
reallocates the same family identification information between the different pieces of the family identification information to the first reference destination meta information and the second reference destination meta information in a similar manner; and
updates the meta information management information so as to manage correspondence among the same family identification information, the intra-family identification information that uniquely identifies the primary logical volume and the secondary logical volume within the family corresponding to the same family identification information, the first reference destination meta information and the second reference destination meta information in the meta information management information in accordance with reallocation of the same family identification information.

8. A data duplication method in a storage system, the method being executed by the storage system including a storage controller which provides a plurality of logical volumes to a host apparatus and which is capable of creating a snapshot as a secondary logical volume that is a duplication of a primary logical volume,
the storage controller
managing respective pieces of information of:
pair management information that manages correspondence between a pair of identification information of the primary logical volume and identification information of the secondary logical volume, the pair indicating a pair relationship of the snapshot between the primary logical volume and the secondary logical volume, and first reference destination meta information indicating a reference destination of data stored in the secondary logical volume; and
primary logical volume management information that manages correspondence between the identification information of the primary logical volume and second reference destination meta information indicating a reference destination of data stored in the primary logical volume;
allocating the same family identification information that uniquely identifies a family to the primary logical volume and the secondary logical volume so that the primary logical volume and the secondary logical volume belong to the same family among families indicating groups of the logical volumes;
allocating intra-family identification information that uniquely identifies the logical volumes within the same family to the first reference destination meta information and the second reference destination meta information;
generating meta information management information that manages correspondence among the family identification information, the intra-family identification information, the first reference destination meta information and the second reference destination meta information;
generating conversion information that manages correspondence among each of the identification information of the primary logical volume and the identification information of the secondary logical volume, the family identification information to which the primary logical volume and the secondary logical volume belong, and the intra-family identification information of the primary logical volume and the secondary logical volume;
acquiring the corresponding family identification information and the corresponding intra-family identification information from the identification information of the primary logical volume and the identification information of the secondary logical volume with reference to the conversion information in response to a request for access to the data stored in the primary logical volume and the secondary logical volume from the host apparatus;
acquiring the first reference destination meta information and the second reference destination meta information respectively corresponding to the primary logical volume and the secondary logical volume with reference to the meta information management information based on the acquired family identification information and intra-family identification information; and
accessing the data stored in the primary logical volume and the secondary logical volume based on the acquired first reference destination meta information and second reference destination meta information.
